(19) United States
(12) Patent Application Publication
(10) Pub. No.: US 2003/0067454 A1
(43) Pub. Date: Apr. 10, 2003

(54) Display device and signal transmission method thereof

(76) Inventors: Hyun-kuk Shin, Suwon-city (KR); II Kim, Yongin-city (KR)

Correspondence Address: Sughrue, Mion, Zinn, Macpeak & Seas, PLLC, 2100 Pennsylvania Avenue, N.W., Washington, DC, 20037-3202, US

(21) Appl. No.: 09/487,237

(22) Filed: Jan. 20, 2000

(30) Foreign Application Priority Data
Jan. 20, 1999 (KP) 99-1642

(51) Int. Cl. G09G 5/00

(52) U.S. Cl. 345/204

(57) ABSTRACT

A display device includes a display portion for displaying an image, a main board for controlling an overall system, and a display portion driving circuit board for driving the display portion. The display device is driven by a serial digital video signal, a clock signal and a control signal transmitted through a cable from a computer. The signals transmitted through the cable from the computer are input to the display portion driving circuit board. The display driving circuit board includes a serial-to-parallel converter for converting an input N-bit packet of a serial digital video signal to an N-bit parallel digital video signal, and a frequency divider for dividing the frequency of the clock signal by N. The display portion is driven by the parallel digital video signal, the divided clock signal and a control signal. The main board controls the system by receiving the control signal via the display portion driving circuit board. Thus, the connection between the main board and the display portion driving circuit board is simple and deterioration of quality in signal transmission is prevented. Also, an additional serial-to-parallel circuit is not needed so that the manufacturing cost is lowered.

### BACKGROUND OF THE INVENTION

1. Field of the Invention

The present invention relates to a display device and a signal transmission method thereof, and more particularly, to a display device and a signal transmission method thereof in which electrical connection between a main board and a display portion driving circuit board is simplified. The present application is based on Korean Patent Application No. 99-1642 which is incorporated herein by reference for all purposes.

2. Description of the Related Art

A general display device is driven by video signals, clock signals (CK) and control signals transmitted through a common wire cable or optical cable from a computer. The video signal is divided into a red video signal (R), a green video signal (G) and a blue video signal (B) and each of the video signals R, G and B is an 8-bit parallel digital signal. The control signal includes a vertical synchronous signal V_{SYNC}, a horizontal synchronous signal H_{SYNC}, and an enable signal EN. When the parallel video signal is transmitted without conversion, many transmission cables are required because multiple channels should be used. Accordingly, a method of converting the parallel digital video signal to a serial digital video signal and transmitting the converted signal to the display device has been suggested. In this case, the serial video signal transmitted from a computer is re-converted to a parallel video signal at the display device to drive a display portion.

A conventional flat panel display device 1 is shown in FIG. 1. Referring to FIG. 1, in the display device 1, a circuit board including a main board 3 and a display portion driving circuit board 9 drives a display portion 10 and controls the display device 1.

The 8-bit packet of serial digital video signals Rs, Gs and Bs, the clock signal CK₂ and the control signal transmitted from a computer 2 are input to the main board 3. The control signal includes a vertical synchronous signal V_{SYNC}, a horizontal synchronous signal H_{SYNC}, and an enable signal EN.

The main board 3 includes a serial-to-parallel converter 4 for converting the serial digital video signals R_{S}, G_{S} and B_{S}, transmitted from the computer 2 to the parallel digital video signals R_{P}, G_{P} and B_{P}, a frequency divider 5 for dividing the frequency of the clock signal CK₂ by 8 and reproducing a clock signal CK₁, and a microprocessor 6 for receiving the control signal and controlling the display device 1, for example, controlling a power saving function of the display device 1.

The converted parallel digital video signals R_{P}, G_{P} and B_{P} converted at the main board 3, the clock signal CK₁ and the control signal are transmitted to the display portion driving circuit board 9 through a ribbon cable 7 electrically connecting the main board 3 and the display portion driving circuit board 9. Among the signals transmitted through the ribbon cable 7, the control signal is a TTL (transistor transistor logic) signal of a low frequency while the parallel video signal is a TTL signal of a high frequency.

In the flat panel display device 1, the parallel signals converted at the main board 3 are transmitted to the display portion driving circuit board 9 through the ribbon cable 7.

However, in this case, as the parallel signals are transmitted from the main board 3 to the display portion driving circuit board 9, the cable connection between the main board 3 and the display portion driving circuit board 9 is complicated and the quality of TTL signal transmitted, in particular, the TTL signal of a high frequency, becomes deteriorated as the signal passes the cable of a predetermined length.

To simplify the cable connection between the main board 3 and the display portion driving circuit board 9, the signals input to the main board 3 from the computer 2 are parallelized and the control signal among the parallelized signals are transmitted to the microprocessor 6 to be used for the control of power saving. Also, the control signal and the parallel video signal are serialized and transmitted to the display portion driving circuit board 9 and then these signals are parallelized again to drive the display portion 10. However, in this case, as serialization/parallelization of signals are needed twice, the manufacturing cost is raised.

### SUMMARY OF THE INVENTION

To solve the above problems, it is an objective of the present invention to provide a display device and a signal transmission method thereof in which the connection between the main board and the display portion driving circuit board is simple and deterioration of transmitted signals is prevented and the cost thereof is low.

Accordingly, to achieve the above objective, there is provided a display device which includes a display portion for displaying an image, a display portion driving circuit board, having a serial-to-parallel converter for converting an input N-bit packet of serial digital video signal to an N-bit parallel digital video signal and a frequency divider for dividing the frequency of a clock signal by N, the display portion driving circuit board driving the display portion by converting a serial digital video signal, the clock signal and a control signal transmitted through a cable from a computer to the parallel digital video signal, the divided clock signal and a control signal suitable for driving the display portion, and a main board for receiving the control signal passing the display portion driving circuit board and controlling an overall system.

To achieve the above objective, there is provided a method of transmitting a signal in a display device including a display portion for displaying an image, a main board for controlling an overall system, and a display portion driving circuit board for driving the display portion and being driven by a serial digital video signal, clock signal and a control signal which are transmitted through a cable from a computer. The method is achieved by inputting the signals transmitted through the cable from the computer to the display portion driving circuit portion, converting the input N-bit packet of the serial digital video signal to an N-bit parallel digital video signal at a serial-to-parallel converter provided at the display portion driving circuit board, dividing the frequency of the clock signal by N at a frequency divider provided at one side of the serial-to-parallel converter, inputting the parallel digital video signal, the divided clock signal and a control signal to the display portion, and inputting the control signal passing the display portion driving circuit board to the main board.

### BRIEF DESCRIPTION OF THE DRAWINGS

The above objective and advantages of the present invention will become more apparent by describing in detail a preferred embodiment thereof with reference to the attached drawings in which:

FIG. 1 is a view showing the structure of a typical flat panel display device;

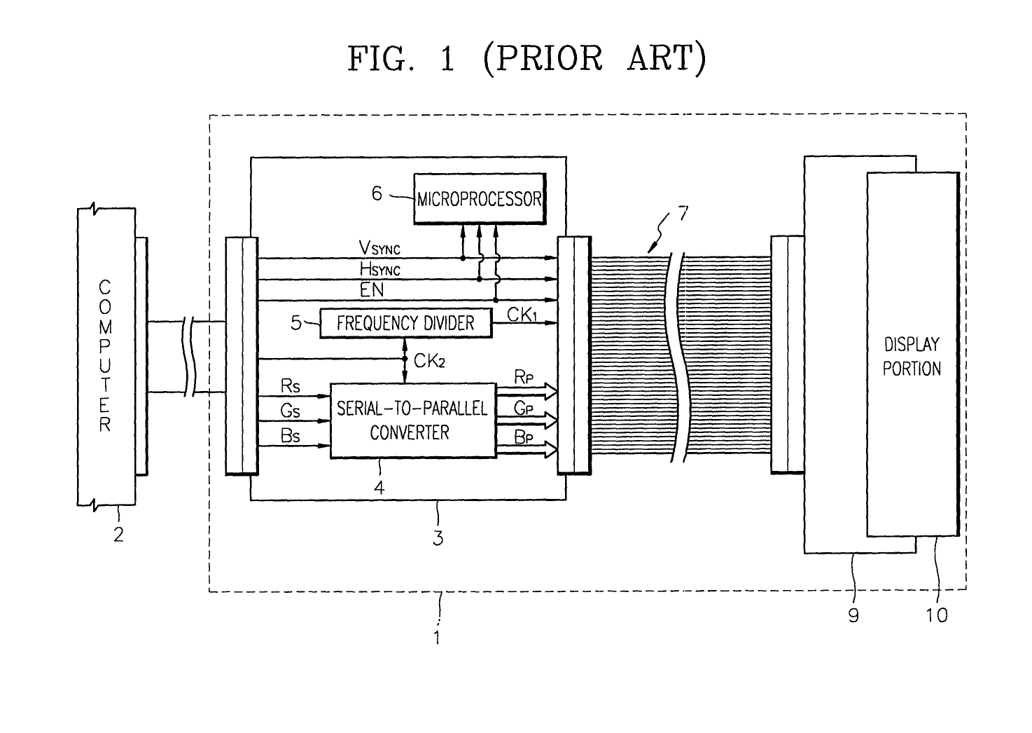

FIG. 2 is a view showing the structure of a display device according to a preferred embodiment of the present invention; and

FIG. 3 is a view showing a part of a display device according to another preferred embodiment of the present invention.

### DETAILED DESCRIPTION OF THE INVENTION

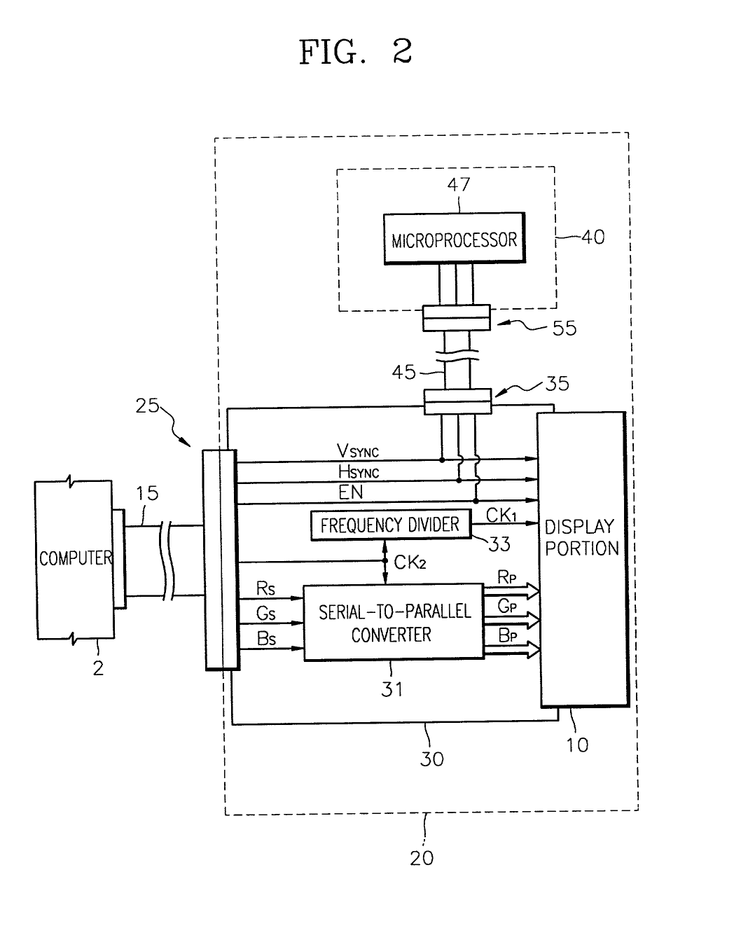

Referring to FIG. 2, a display device 20 according to the present invention is driven by receiving a serial digital video signal, a clock signal and a control signal through a cable from the computer 2. The display device such as a flat panel display device includes a display portion 10 for displaying an image, a main board 40 for controlling the overall system and a display portion driving circuit board 30 for driving the display portion 10.

Here, the computer 2 includes a parallel-to-serial converter (not shown) for converting 8-bit red, green and blue parallel digital video signals R_{P}, G_{P} and B_{P} to 8-bit packet of serial digital video signals R_{S}, G_{S} and B_{S}, respectively, and a frequency multiplier (not shown) for controlling the operation of the parallel-to-serial converter by generating a clock signal CK₂ having a frequency which is 8 times larger than the frequency of a clock signal CK₁ input along with the parallel video signals R_{P}, G_{P} and B_{P}.

In the present preferred embodiment, the 8-bit packet of serial digital video signals R_{S}, Gₛ and B_{S}, the clock signal CK₂ and the control signal transmitted through a cable 15 from the computer 2 are input to the display portion driving circuit board 30. Here, reference numeral 25 denotes a connector module by which the cable 15 is connected to the display device 20.

The display portion driving circuit board 30 includes a serial-to-parallel converter 31 and a frequency divider 33. The serial-to-parallel converter 31 is operated according to the clock signal CK₂ input from the computer 2 to restore the 8-bit packet of serial digital video signals R_{S}, G_{S} and B_{S}, into 8-bit parallel digital video signals R_{P}, G_{P} and B_{P}, respectively. The frequency divider 33 divides the frequency of the clock signal CK₂ by 8 to reproduce the clock signal CK₁.

The control signal includes a vertical synchronous signal V_{SYNC}, a horizontal synchronous signal H_{SYNC}, and an enable signal EN, and is input to the display portion driving circuit board 30 from the computer 2 through different channels of the cable 15. When the computer 2 generates a composite synchronous signal C_{SYNC} by performing the logical sum of the vertical synchronous signal V_{SYNC} and the horizontal synchronous signal H_{SYNC}, according to the enable signal EN and transmits the generated signal to the display device 20 through a channel of the cable 15, it is preferable that the display portion driving circuit board 30 includes a circuit (not shown) for separating the composite synchronous signal C_{SYNC} to the vertical synchronous signal V_{SYNC} and the horizontal synchronous signal H_{SYNC}.

The display portion driving circuit board 30 transmits the converted parallel video signals R_{P}, G_{P} and B_{P}, the clock signal CK₁ divided into ⅛ and restored to the original frequency, and the control signal through different channels, to the display portion 10, to drive the display portion 10. Here, these signals pass a circuit such as a timing controller chip (not shown) provided at the display portion driving circuit board 30, and are used to drive the display portion 10.

Here, the parallel video signals R_{P}, G_{P} and B_{P}, are high frequency TTL signals while the vertical synchronous signal V_{SYNC}, the horizontal synchronous signal H_{SYNC} and the enable signal EN are low frequency TTL signals.

Here, as the high frequency TTL signal is input to the display portion 10 through a lead wire on the display portion driving circuit board 30 which is relatively short in length, the quality of transmitted signal is not lowered.

The control signal branched from a control signal transmission channel provided at the display portion driving circuit board 30 is input to a main board 40 through a cable 45, preferably a ribbon cable. Here, a microprocessor 47 for controlling a power saving function of the display device 20, etc., by receiving the control signal is installed at the main board 40.

As described above, according to the present invention, as only the control signal is input to the main board 40, the cable connection between the display portion driving circuit board 30 and the main board 40 is simplified. Here, the reference numerals 35 and 55 indicate connector modules for connecting one end of the cable 45 and the display portion driving circuit board 30, and connecting the other end of the cable 45 and the main board 40, respectively.

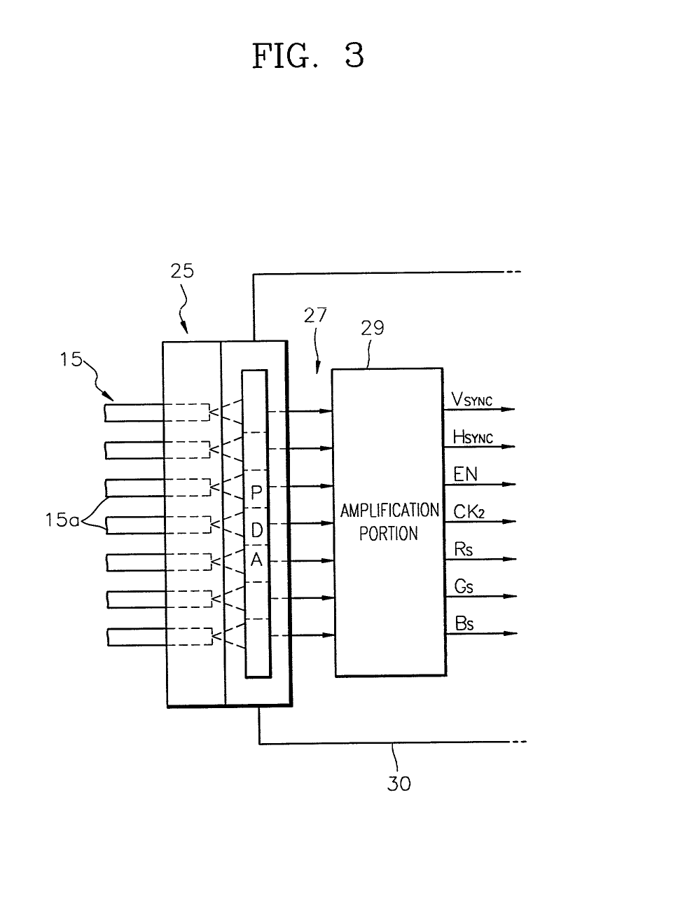

Preferably, the cable 15 through which the signals from the computer are transmitted to the display device 20 is an optical cable, as shown in FIG. 3. When an optical cable 15 is used as the cable, as shown in FIG. 3, an optical detection unit 27 for converting an optical signal transmitted through the optical cable 15 to an electrical signal is provided at the display device. The optical detection unit 27, as shown in the drawing, can be installed at the connector module 25. In a case of the signal transmission using light, the connector module 25 is an optical connector module including a ferrule (not shown) for supporting the optical cable 15.

The optical detection unit 27 may include a photodiode array PDA for receiving optical signals transmitted through each of optical fiber channels 15a constituting the optical cable 15, and converting the received optical signals to electric signals. Also, the optical detection unit 27 may further include an amplification portion 29 for amplifying an output signal of the photodiode array PDA and outputting an 8-bit packet of serial digital video signals R_{S}, G_{S} and B_{S}, the clock signal CK₂ and the control signal.

When the signal is transmitted through the optical cable 15 between the computer 2 and the display device 20, the computer 2 is provided with a semiconductor laser array (not shown) for converting the serial digital video signals R_{S}, Gₛ and B_{S}, the clock signal CK₂ and the control signal to optical signals and the light emitted from each of the semiconductor laser array is input to each of the optical fiber channels forming the optical cable 15.

The process of how the signals are transmitted in the display device according to the present invention is described below.

The 8-bit packet of serial digital video signals R_{S}, G_{S} and B_{S}, the clock signal CK₂ and the control signal transmitted to the display device 20 from the computer 2 through the cable 15 are input to the display portion driving circuit board 30. The inputted 8-bit packet of serial digital video signals R_{S}, G_{S} and B_{S}, is converted to, that is, restored to, 8-bit parallel digital video signals according to the clock signal CK₂ by the serial-to-parallel converter 31. The frequency of clock signal CK₂ is divided by N by a frequency divider 33 provided at one side of the serial-to-parallel converter 31 and is restored to the clock signal CK₁.

The converted parallel digital video signals R_{P}, G_{P} and B_{P}, the clock signal CK₁ and the control signals such as the vertical synchronous signal V_{SYNC}, the horizontal synchronous signal H_{SYNC} and the enable signal EN via the display portion driving circuit board 30 are transmitted to the display portion 10 to drive the display portion 10. The control signals such as the vertical synchronous signal V_{SYNC}, the horizontal synchronous signal H_{SYNC} and the enable signal EN via the display portion driving circuit board 30 are transmitted to the main board 40 and used so that the microprocessor 47 installed at the main board 40 controls the power saving function of the display device 20.

As described above, according to the present invention, the connection between the main board and the display portion driving circuit board is simple and deterioration of quality in signal transmission is prevented. Also, an additional serial-to-parallel circuit is not needed so that the manufacturing cost is lowered.

What is claimed is:

1. A display device comprising:
a display portion for displaying an image;
a display portion driving circuit board, having a serial-to-parallel converter for converting an input N-bit packet of a serial digital video signal to an N-bit parallel digital video signal and a frequency divider for dividing the frequency of a clock signal by N to generate a divided clock signal, the display portion driving circuit board being operative to drive the display portion by converting the serial digital video signal, the clock signal and a control signal transmitted through a cable from a computer to the parallel digital video signal, the divided clock signal and a control signal suitable for driving the display portion; and
a main board for receiving the control signal from the display portion driving circuit board and controlling an overall system.

2. The display device claimed in claim 1, wherein the cable is an optical cable, and further comprising an optical detection unit for converting an optical signal transmitted through the optical cable to an electrical signal.

3. A method of transmitting a signal in a display device including a display portion for displaying an image, a main board for controlling an overall system, and a display portion driving circuit board for driving the display portion and being driven by a serial digital video signal, a clock signal and a control signal which are transmitted through a cable from a computer, the method comprising the steps of:
inputting the signals transmitted through the cable from the computer to the display portion driving circuit portion;
converting the input serial digital video signal from an N-bit packet serial digital video signal to an N-bit parallel digital video signal at a serial-to-parallel converter provided at the display portion driving circuit board;
dividing the frequency of the clock signal by N at a frequency divider provided at one side of the serial-to-parallel converter to generate a divided clock signal;
inputting the parallel digital video signal, the divided clock signal and a control signal to the display portion; and
inputting the control signal from the display portion driving circuit board to the main board.

4. A display device comprising:
a display portion for displaying an image;
a display portion driving circuit board which receives a serial digital video signal and a control signal, and outputs a parallel digital video signal and the control signal to the display portion via an optical cable; and
a main board which receives the control signal from said display portion driving circuit board and controls overall system operation.

5. The display device of claim 4, wherein the serial digital video signal comprises N-bit packets of serial digital video data and said display portion driving circuit board comprises a serial-to-parallel converter for converting the N-bit packets of serial digital video data to N-bit parallel digital video data.

6. The display device of claim 5, wherein said display portion driving circuit board further receives a clock signal associated with the serial digital video signal and comprises a frequency divider for dividing the frequency of the clock signal by N to generate a divided clock signal which is output to said display portion for driving said display portion.

7. A method of transmitting a signal in a display device including a display portion for displaying an image, a main board for controlling overall operation of a system and a display portion driving circuit board for driving the display portion, the method comprising:
(a) receiving, at the display portion driving circuit board, a serial digital video signal and a control signal;
(b) converting, at the display portion driving circuit board, the received serial digital video signal into a parallel digital video signal;
(c) inputting the parallel digital video signal to the display portion through an optical cable; and
(d) inputting the control signal, received by the display portion driving circuit board, to the main board.

8. The method of claim 7, wherein the serial digital video signal comprises N-bit packets of serial digital video data, and the step (b) converts the N-bit packets of serial digital video data into N-bit parallel.

9. The method of claim 8, wherein the display portion driving circuit board further receives a clock signal and divides the clock signal by N to generate a divided clock signal, and inputs the divided clock signal to the display portion.
